(19) United States
(12) Patent Application Publication
(10) Pub. No.: US 2017/0265433 A1
(43) Pub. Date: Sep. 21, 2017

(54) SELF-SUPPORTING CARDBOARD CAT SCRATCHER

(71) Applicant: Worldwise, Inc., Novato, CA (US)

(72) Inventors: Victoria Davila, San Francisco, CA (US); Charles Floyd, Oakland, CA (US); Michael Risso, Napa, CA (US); Hannah Rosenberg, San Francisco, CA (US)

(21) Appl. No.: 15/072,022

(22) Filed: Mar. 16, 2016

(51) Int. Cl. A01K 15/02

(52) U.S. Cl. CPC A01K 15/024

(57) ABSTRACT

A kit for providing a scratcher for use by a pet cat. The kit includes first and second scratching elements of first and second widths, the scratching elements being self-supporting cardboard bodies, each having open fluted faces. The kit also includes at least one connector having a shaft of a length greater than the first width and less than the combination of the first and second widths, the connector further having helical threads along its shaft, at least a portion of the helical threads sized to extend from the shaft to deform flutes of the first and second scratching elements.

### TECHNICAL FIELD

The present invention is directed to a self-supporting cardboard cat scratcher for providing scratching surfaces of the type used by domestic cats. The device can be shipped and warehoused as a kit of individual parts and which is designed to be easily assembled by a pet owner.

### BACKGROUND OF THE INVENTION

It is well recognized that domestic cats crave scratching as part of their natural and instinctive character. If a dedicated scratching surface is not provided, domestic cats would generally satisfy their need to scratch by turning to furniture, curtains and other articles which may be substantially damaged as a consequence. Often times, pet cats will not only climb over furniture, especially upholstered chairs and sofas, but will use such furniture and carpeting to condition their claws through deliberate repeated clawing, pulling and tearing actions specifically with their forepaws. As noted, this clawing activity appears to be an irresistible natural impulse for cats and can be the source of great aggravation to the pet owner As such, a dedicated scratcher is a necessity for any cat owner

A number of vendors of pet and pet related products have offered dedicated scratching posts and surfaces in order to ameliorate this problem. Scratching posts are generally sold as fully assembled constructs, thus obviating the need to assemble the scratcher from a kit of parts. Vendors of such products generally opt to warehouse and sell assembled scratchers as many owners do not have ready access to the tools necessary for assembly. Furthermore, virtually all cat scratchers are provided with some type of substructure which supports a scratching surface. This substructure, usually composed of wood or plastic, results in an environmental waste burden as the cat owner will discard the scratcher once the scratching surface has been significantly degraded. Even if such products provide for the replacement of scratching surfaces, eventually, the assembly will be discarded, again, resulting in an environmental burden

As noted above, most scratchers are sold as assembled posts and the like There are certainly drawbacks in shipping and promoting for sale fully assembled scratchers Among them are shipping costs which represent a significant fraction of the products' overall price. It has become increasingly common to manufacture such products offshore where labor costs are less than those in this country This is particularly true as it pertains to the manufacture of non-complex or relatively low end products which can be assembled by relatively unskilled labor. However, as manufacturing has shifted offshore, shipping costs have become an increasingly more significant percentage of product pricing.

Typically, manufactured goods produced in Asia are imported into the United States on commercial vessels, These goods are not only manufactured but packaged at Asian factories and multiple units placed within cardboard containers or otherwise bundled in groups for placement within cargo containers which are, in turn, stacked atop one another in appropriately configured vessels. The shipping cost per item is dictated by the number of such items which can be placed within shipping containers as the cost per transoceanic passage substantially remains fixed.

Certain items, such as televisions, stereos, computers and semiconductor chips can be conveniently stacked within rectangular shipping containers as such products are usually enclosed within square or rectangular boxes which optimally stack in such containers. However, self-supporting scratchers, if shipped assembled, cannot be densely packed within transoceanic shipping containers and thus, the cost of shipping such products can be inordinately high. In addition, once such products are received by a retailer, warehousing them can be a challenge as a fully assembled scratcher occupies more warehousing space than is justified by the price of the product This also pertains to the inordinately excessive shelf space that such a product would occupy noting that inefficient shelving negatively impacts profitability.

It is thus an object to the present invention to provide a self-supporting scratcher which is devoid of any supporting substructure, the use of which would result in an environmental burden once the scratcher has been discarded.

It is yet a further object to the present invention to provide a self-supporting cardboard scratcher, an ideal scratching medium for a cat being subject to degradation without harming the cat as the scratcher is employed.

Yet a further object of the present invention is to provide a self-supporting scratcher which can be purchased by a pet owner in kit form and easily assembled without the use of tools or by engaging in complex assembly steps.

Still yet a further object of the present invention is to provide a scratcher that can be shipped, warehoused and displayed compactly and assembled by a pet owner easily and without the need of tools These and further objects we more readily apparent when considering the following disclosure and appended claims

### SUMMARY OF THE INVENTION

A kit for providing a scratcher for use by a pet cat, said kit comprising first and second scratching elements of first and second widths comprising self-supporting cardboard bodies, each having open fluted faces, at least one connector comprising a shaft of a length greater than said first width and less than the combination of said first and second widths, said connector further comprising helical threads along said shaft, at least a portion of said helical threads sized to extend from said shaft to deform flutes of said first and second scratching elements

### BRIEF DESCRIPTION OF THE FIGURES

FIG. 1 is a perspective view of a two-piece cardboard scratcher nested for shipment and storage.

FIG. 2 is a perspective view of the two-piece cardboard scratcher of FIG. 1 rearranged for use by a pet cat shown in partial assembly.

FIGS. 3A, 3B and 3C are plan views of suitable connector elements for use in the kit constituting the present invention.

FIG. 4 is a cross-sectional view taken along 4-4 of FIG. 2

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

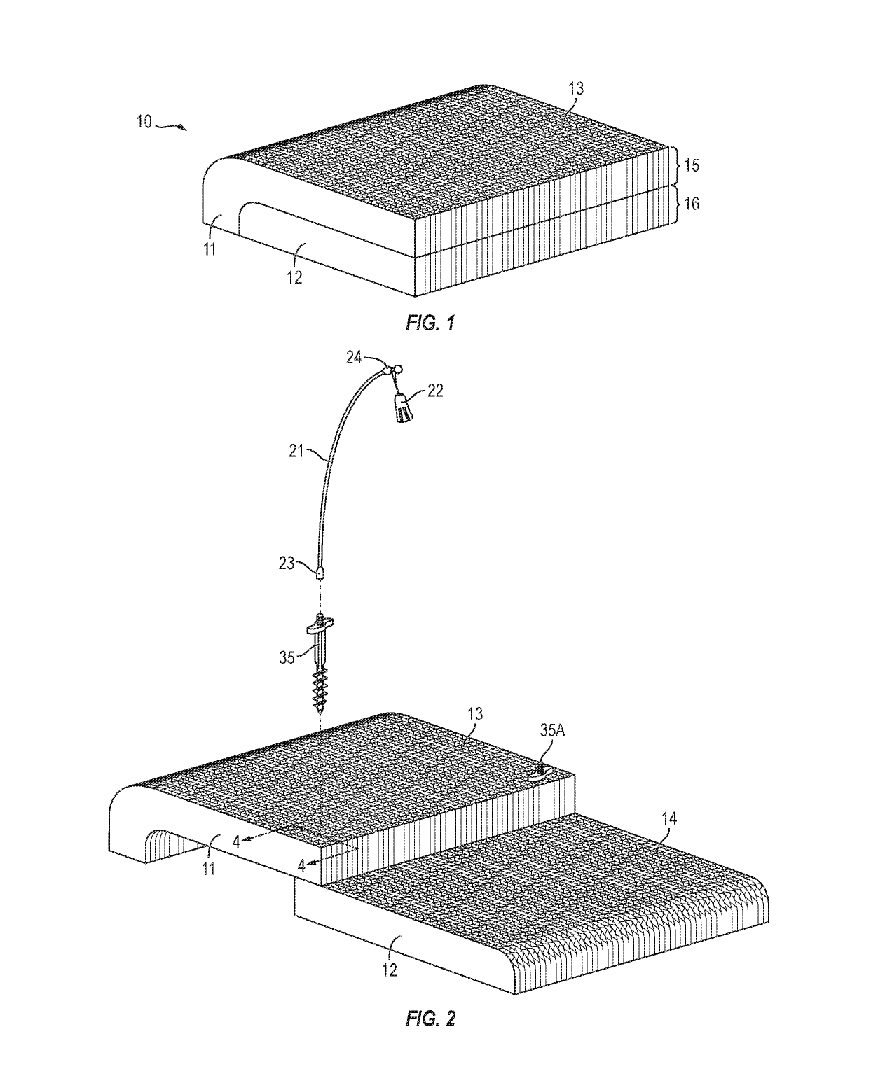

Turning to FIG. 1, cardboard scratcher elements 11 and 12 are shown being nested within one another to reduce their overall volume during shipment and storage. Each cardboard element is self-supporting having no backing or substructure and each has exposed surfaces, namely, surfaces 13 and 14 having open flutes 8 and 9 interposed between planar cardboard sheets 7A/7B and 6A/6B respectively (FIG. 4). In preparing scratcher 10 for use, scratcher element 12 is moved from its nested position (FIG. 1) to its in-use position (FIG. 2) by removing scratcher element 12 from beneath scratcher element 11 and rotating it 180° as shown in FIG. 2 It must be emphasized at this time that scratcher 10 composed of subparts 11 and 12 is illustrative of a kit of parts composed of self-supporting cardboard bodies which can be nested for shipment and storage and rearranged for use and that the present invention is not to be limited to this illustrated structure but applies to any kit, the scope of which is defined by the appended claims

Once scratcher element 12 has been moved from beneath scratcher element 11 as shown in FIG. 2, connectors such as connectors 35 and 35A can be applied to maintain the FIG. 2 orientation. In doing so, it is noted that both surfaces 13 and 14 provide open fluted faces which is an ideal scratching medium for a cat

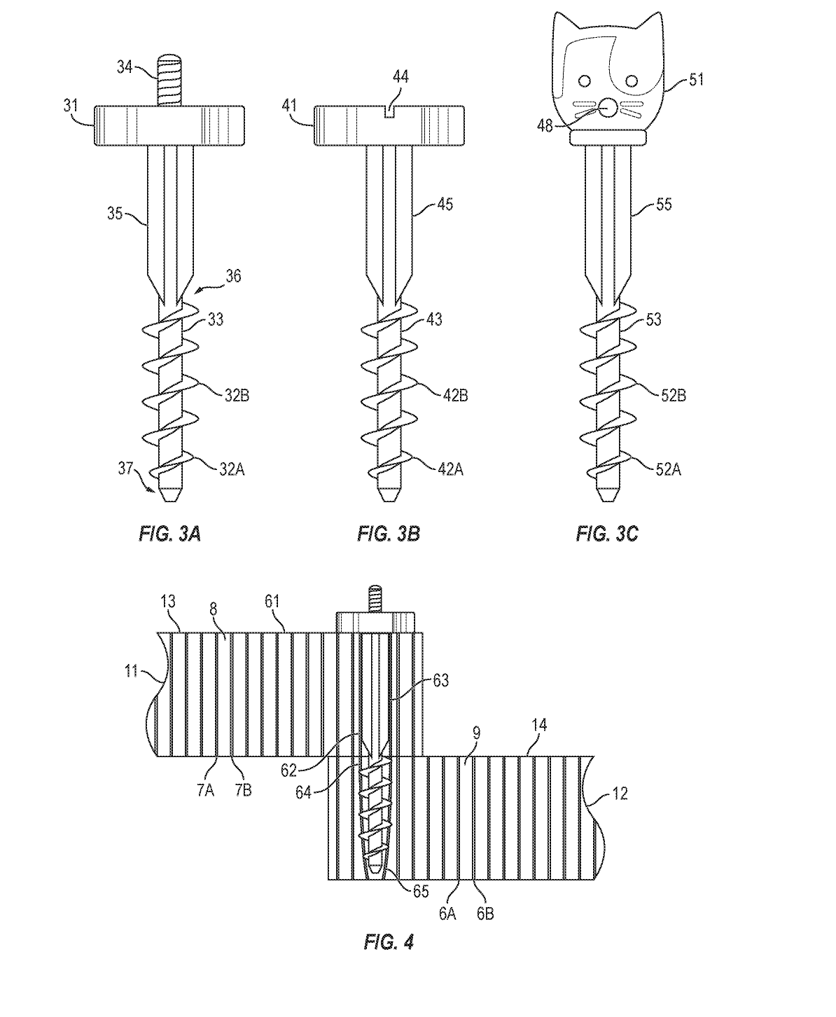

In returning again to FIG. 2, and in reference to FIG. 3A, connector elements 35 and 35A are provided with shaft 33 of a length greater than first width 15 of scratcher element 11 and less than the combination of first and second widths 15 and 16 Further, connectors 35 and 35A are provided with helical threads 32A and 32B along shaft 33 noting that helical threads 32A extend from shaft 33 to a lesser extent proximate second end 37 than threads 32B proximate first and 36 thereof. This facilitates application of connectors 35 and 35A as shown.

There are a number of suitable variations of connectors for use herein, those depicted in FIGS. 3A-3C being illustrative of many of which can be employed in practicing the present invention. For example, connector 35 are provided with helical male protrusion 34 sized to receive female end 23 of wand 21 which, in turn, supports attractant 22 at end 24 Protrusion 34 extends from head 31, the latter being sized and configured to enable a pet owner to apply the connector as shown in FIG. 2 without resorting to any tools. Thus, connector 35 not only maintain the orientation of scratching elements 11 and 12 for use as a scratcher but also can support a wand and an attractant making the present scratcher more interesting to the pet. As wand 21 is removable from these connectors, wands of various sizes and diverse attractants can be releasably applied to the scratcher to increase its appeal and reduce the potential for boredom

As further non-limiting examples of suitable connectors, reference is made to FIGS. 3B and 3C As was the case with the connector of FIG. 3A, connectors 45 and 55 have shafts 43 and 53 of suitable length and are provided with helical threads 42A/42B and 52A/52B, respectively. In the example of FIG. 3B head 41 comprises indent 44 for receiving a screwdriver or coin to facilitate turning the connector within the flutes of scratcher elements 11 and 12. As for the connector illustrated in FIG. 3C, head region 51 is arbitrarily depicted as the head of a cat. This substantially planar extension is sized to enable a user to grasp it and to turn the connector within the receiving flutes Furthermore, head region 51 includes opening 48 to enable an umbilical (not shown) to be tied to head region 51 for support of a suitable attractant, such as attractant 22 of FIG. 2

In turning to FIG. 4, a cross-section taken along 4-4 of FIG. 2 is shown together with connector 35. Shaft 33 is inserted within one of flutes 8 extending into exposed surface 13. As connector 35 is rotated, helical threads 32A begin to deform flutes 8 and cause shaft 33 to be drawn within the body of scratching element 11. As connector 35 continues to penetrate scratching element 11, helical threads 32B further deform flutes 8 as well as adjacent cardboard sheets 62 and 63 as shown. In fact, in most instances, helical threads 32B are sufficient to break cardboard sheets 62 and 63 on either side of receiving flute 8. As connector 35 continues to progress, it confronts surface 14 of scratching element 12 penetrating one of flutes 9 causing a similar deformation of cardboard sheets 64 and 65

The above disclosure is sufficient to enable one of ordinary skill in the art to practice the invention, and provides the best mode of practicing the invention presently contemplated by the inventor While there is provided herein a full and complete disclosure of the preferred embodiments of the invention, it is not desired to limit the invention to the exact construction, dimensions, relationships, or operations as described Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A kit for providing a scratcher for use by a pet cat, said kit comprising first and second scratching elements of first and second widths, said scratching elements comprising self-supporting cardboard bodies, each having open fluted faces, at least one connector comprising a shaft of a length greater than said first width and less than the combination of said first and second widths, said connector further comprising helical threads along said shaft, at least a portion of said helical threads sized to extend from said shaft to deform flutes of said first and second scratching elements.

2. The kit of claim 1 wherein said first and second scratching elements nest to assume a first orientation during storage and shipment and a second orientation during use.

3. The kit of claim 2 wherein said at least one connector connects said first and second scratching elements when in said second orientation

4. The kit of claim 1 wherein said shaft comprises a first end and a second end wherein said at least one connector comprises a head region located at said first end, said second end sized for insertion within said open flutes.

5. The kit of claim 4 wherein said helical threads extend from said shaft to a lesser degree proximate the second end of the shaft than proximate the first end thereof

6. The kit of claim 1 further comprising a wand, said wand having first and second ends, said head region further comprising a wand receiving member, said wand being releasably attached to said head region by releasing attaching said first wand and to said wand receiving member

7. The kit of claim 6 wherein a cat attractant is appended to and supported by the second end of said wand

8. The kit of claim 4 wherein said head region comprises an opening for appending an umbilical thereto

9. The kit of claim 4 wherein said head region is sized to enable a user to grasp said head region to facilitate turning said connector within said flutes.

10. The kit of claim 4 wherein said head region comprises in indent fox receiving a screwdriver or coin to facilitate turning said connector within said flutes.

11. The kit of claim 1 wherein said flutes are interposed between planar cardboard sheets, at least a portion of said helical threads being sized to deform said planar cardboard sheets on both sides of said flutes to which said at least one connector has been inserted
